(19) United States
(12) Patent Application Publication
(10) Pub. No.: US 2018/0207780 A1
(43) Pub. Date: Jul. 26, 2018

(54) DETACHABLE HAND TOOL MADE OF DIFFERENT MATERIALS

(71) Applicant: LU KANG HAND TOOLS INDUSTRIAL CO., LTD., Chunghwa Hsien (TW)

(72) Inventor: Yi-Kung HUNG, Chunghwa Hsien (TW)

(73) Assignee: LU KANG HAND TOOLS INDUSTRIAL CO., LTD., Chunghwa Hsien (TW)

(21) Appl. No.: 15/415,577

(22) Filed: Jan. 25, 2017

(51) Int. Cl. B25D 1/04; B25D 1/12

(52) U.S. Cl. CPC B25D 1/04; B25D 2250/065; B25D 1/12

(57) ABSTRACT

A hand tool has a handle, a first working portion, and a second working portion. The hand is elongated and has a top. The first working portion and the second working portion are detachably connected respectively with two ends of the top of the handle. Each one of the first working portion and the second working portion is made of a material different from a material of the handle.

### BACKGROUND OF THE INVENTION

### 1. Field of the Invention

The present invention relates to a hand tool, and more particularly to a hand tool that is detachable and made of different materials.

### 2. Description of Related Art

With reference to FIGS. 8 and 9, a conventional detachable hand tool substantially comprises a handle 60, a first working portion 62 and a second working portion 64. The first working portion 62 is integrally formed on one end of a top of the handle 60 as a single part, and the second working portion 64 is detachably mounted on an end of the top of the handle 60 opposite the first working portion 62 by a connection bolt 66. The connection bolt 66 is mounted through the top of the handle 60 and is screwed with the second working portion 64 to securely connect the second working portion 64 with the handle 60. Accordingly, after the releasing the connection bolt 66 from the second working portion 64, the second working portion 64 can be replaced with a new working portion either in the same or in a different form.

However, because the first working portion 62 is integrally formed with the handle 60, the first working portion 62 is not detachable from the handle 60. Therefore, the first working portion 62 cannot be replaced with a new one when the first working portion 62 is damaged, and the first working portion 62 cannot be replaced with another working portion in a different form to conduct different work. Thus, the conventional hand tool is not versatile in use.

To overcome the shortcomings, the present invention tends to provide a hand tool to mitigate or obviate the aforementioned problems.

### SUMMARY OF THE INVENTION

The main objective of the invention is to provide a hand tool that is detachable and versatile in use

The hand tool has a handle, a first working portion, and a second working portion. The handle is elongated and has a top. The first working portion and the second working portion are detachably connected respectively with two ends of the top of the handle. Each one of the first working portion and the second working portion is made of a material different from a material of the handle.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a hand tool in accordance with the present invention;

FIG. 2 is an enlarged partially exploded perspective view of the hand tool in FIG. 1;

FIG. 3 is an enlarged cross sectional front view of the hand tool in FIG. 1;

FIG. 4 is a perspective view of a second embodiment of a hand tool in accordance with the present invention;

FIG. 5 is an enlarged partially exploded perspective view of the hand tool in FIG. 4;

FIG. 6 is another enlarged partially exploded perspective view of the hand tool in FIG. 4;

FIG. 7 is an enlarged cross sectional front view of the hand tool in FIG. 4;

FIG. 8 is a front view in partial section of a conventional hand tool; and

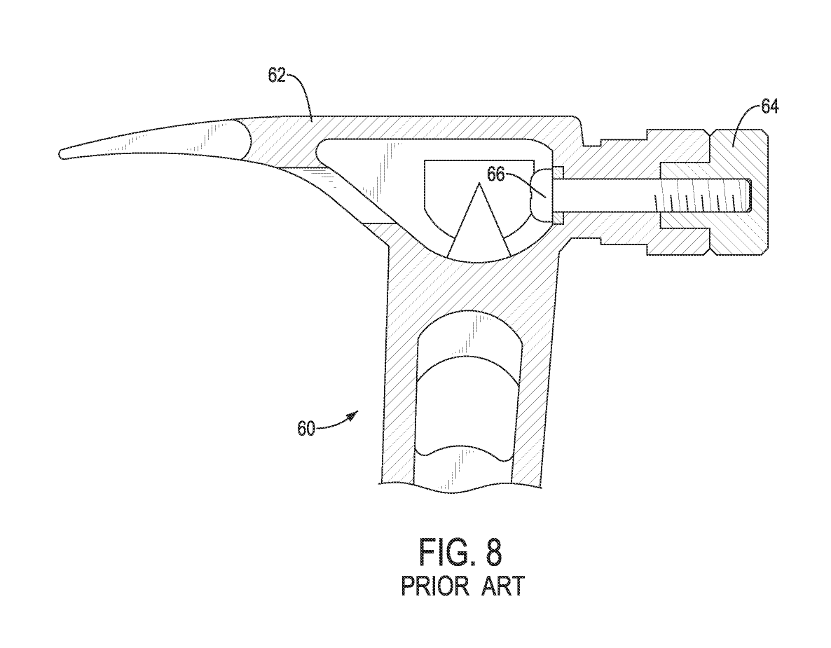

FIG. 9 is an exploded front view in partial section of the hand tool in FIG. 8.

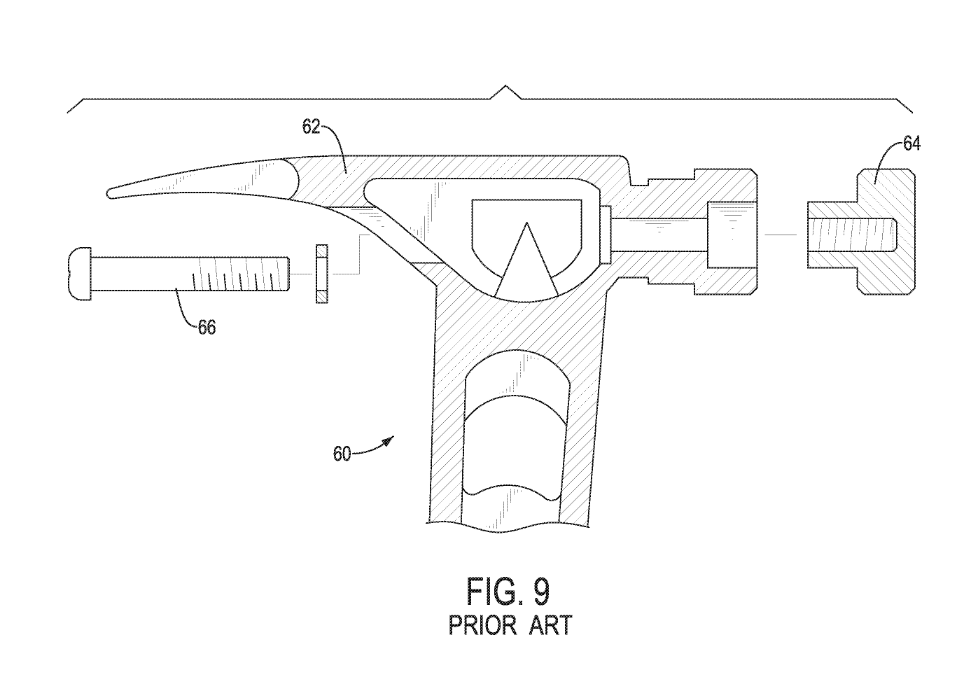

### DETAILED DESCRIPTION OF PREFERRED EMBODIMENT

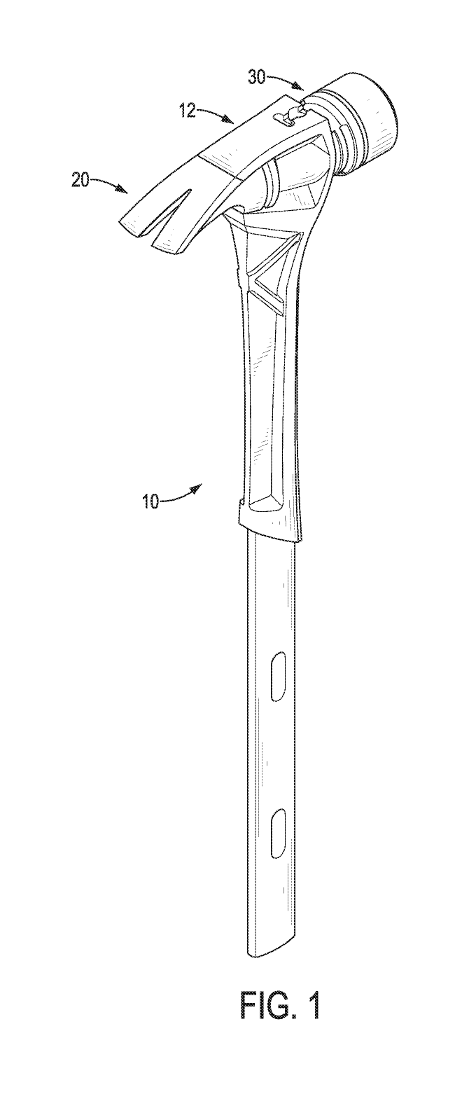

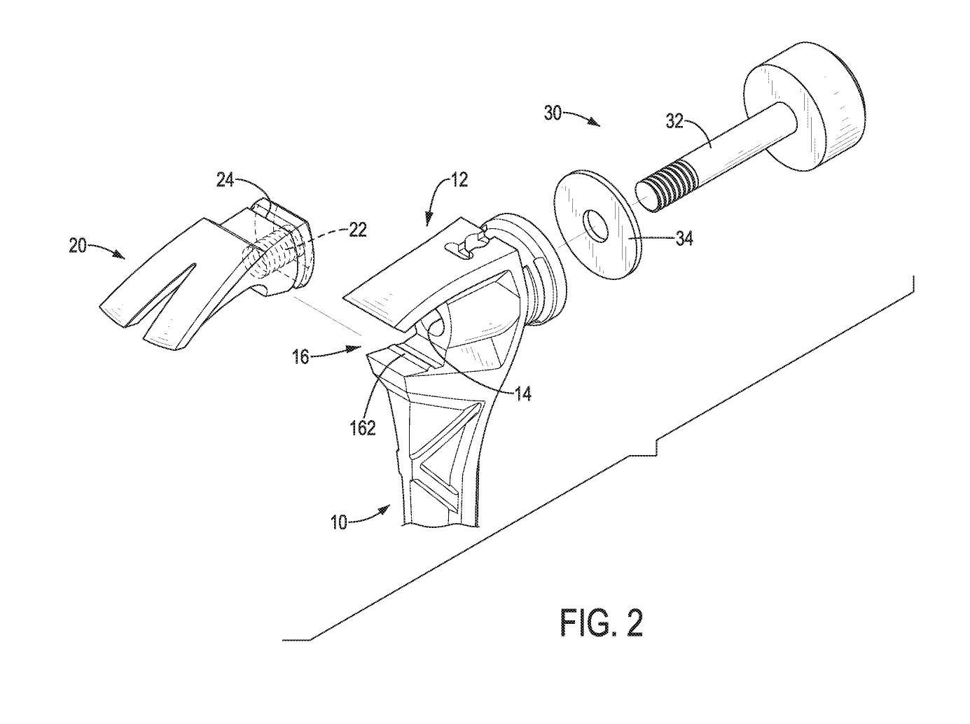

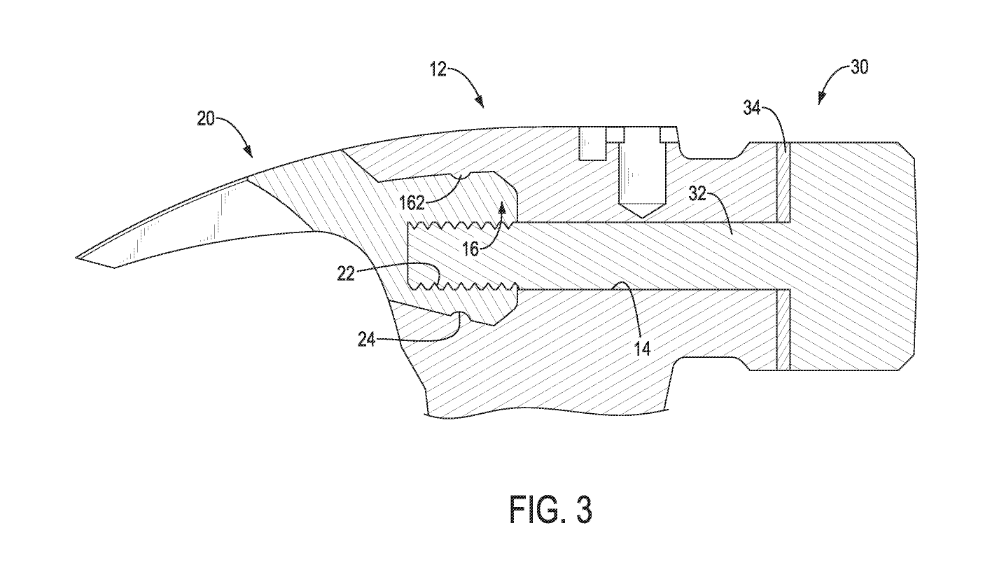

With reference to FIGS. 1 to 3, a hand tool in accordance with the present invention comprises a handle 10, a first working portion 20, and a second working portion 30.

The handle 10 is elongated and has a top 12. The first working portion 20 and the second working portion 30 are detachably connected respectively with two ends of the top 12 of the handle 10. Each one of the first working portion 20 and the second working portion 30 is made of a material different from a material of the handle 10. Preferably, the handle 10 may be made of a light material, such as aluminum or plastic steel, and the working portions 20, 30 may be made of a heavy material, such as steel.

In the first embodiment, the handle 10 has a through hole 14 defined through the two ends of the top 12. The first working portion 20 has a threaded hole 22 defined in an end of the first working portion 20 facing the top 12 of the handle 10. The second working portion 30 has a connection bolt 32. The connection bolt 32 is formed on and protrudes from an end of the second working portion 30 facing the top 12 of the handle 10, extends through the through hole 14 in the top 12 of the handle 10, and is screwed with the threaded hole 22 in the first working portion 20. With the connection bolt 32, the first working portion 20 and the second working portion 30 are detachably connected with the top 12 of the handle 10.

In addition, the first working portion 20 further has at least one annular engaging groove 24 defined around the first working portion 20. The handle 10 further has a clamping notch 16 defined in the end of the top 12 of the handle 10 that faces the first working portion 20, and the clamping notch 16 communicates with the through hole 14. The clamping notch 16 has two inner sides facing each other. Each inner side has at least one engaging rib 162 formed on and protruding from the inner side and engaging respectively with the at least one engaging groove 24 in the first working portion 20. With the engagement between the at least one engaging rib 162 and the at least one engaging groove 24, the connection between the top 12 of the handle 10 and the first working portion 20 is enhanced. A shock-absorbing gasket 34 is resilient and is mounted around the connection bolt 32 and is clamped between the second working portion 30 and the end of the top 12 of the handle 10 facing the second working portion 30 to absorb the shock generating during the operation of the second working portion 30.

With such an arrangement, the working portions 20, 30 can be detached from the handle 10 after the connection bolt 32 is released from the threaded hole 22 in the first working portion 20. Consequently, a new working portion 20, 30 can be connected with the handle 10 when any one of the working portions 20, 30 is damaged. In addition, a working portion in a different form can be connected with the handle 10 to conduct different work. Therefore, the hand tool in accordance with the present invention is versatile in use. Furthermore, because the handle 10 is made of a light material different from the heavy materials of the working portions 20,30, the weight of and the cost for manufacturing the hand tool can be effectively reduced.

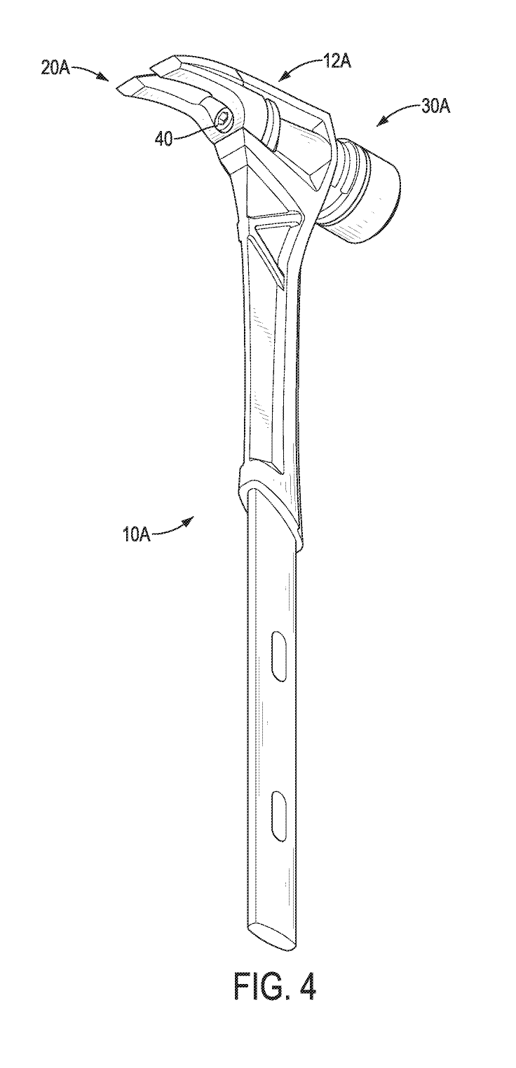

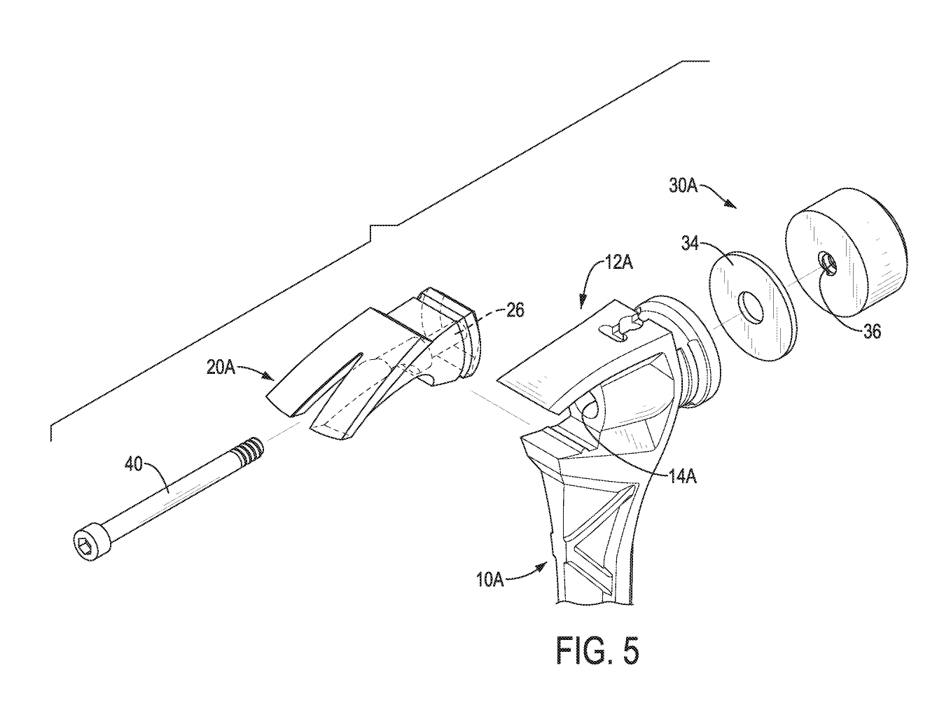

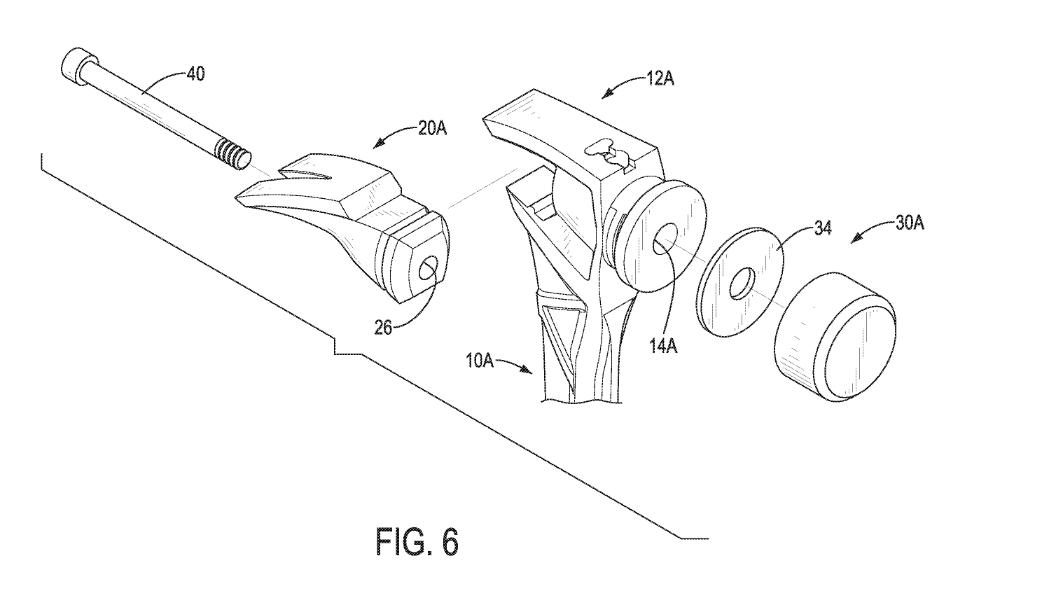

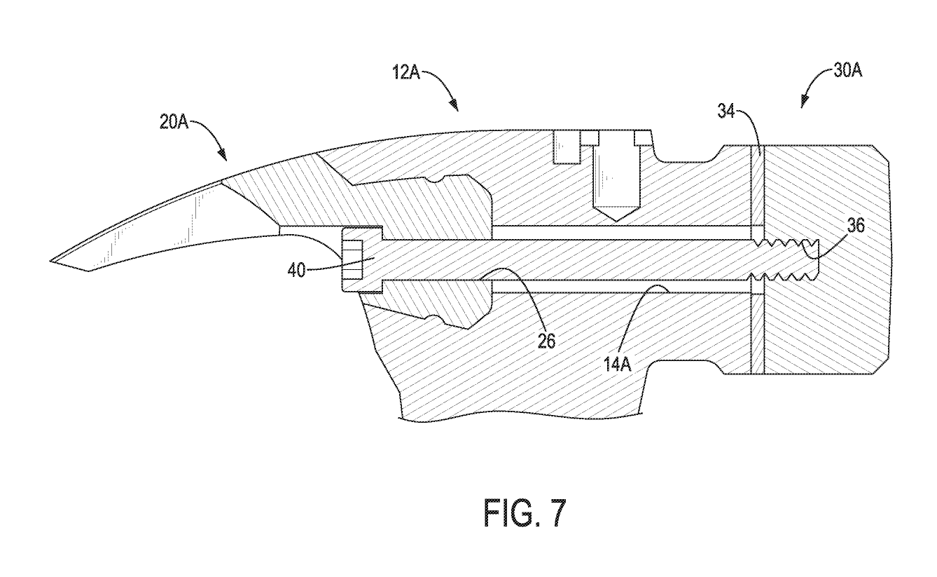

With reference to FIGS. 4 to 7, in the second embodiment, the handle 10A has a through hole 14A defined through the two ends of the top 12A. The first working portion 20A has a through hole 26 defined through the first working portion 20A and aligned with the through hole 14A in the handle 10A. The second working portion 30A has a threaded hole 36 defined in an end of the second working portion 30A facing the top 12A of the handle 10A and aligned with the through hole 14A in the handle 10A. A connection bolt 40 is mounted through the through holes 14A, 26 in the first working portion 20A and the handle 10A and is screwed with the threaded hole 36 in the second working portion 30A. A shock-absorbing gasket 34 is mounted around the connection bolt 40 and clamped between the second working portion 30A and the end of the top 12A of the handle 10A that faces the second working portion 30A.

Accordingly, the working portions 20A, 30A can be detachably connected with the top 12A of the handle 10A.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hand tool comprising:
an elongated handle having a top;
a first working portion and a second working portion detachably connected respectively with two ends of the top of the handle, and each one of the first working portion and the second working portion made of a material different from a material of the handle.

2. The hand tool as claimed in claim 1, wherein
the handle has a through hole defined through the two ends of the top;
the first working portion has a threaded hole defined in an end of the first working portion facing the top of the handle; and
the second working portion has a connection bolt formed on and protruding from an end of the second working portion facing the top of the handle, the connection bolt extending through the through hole in the top of the handle and screwed with the threaded hole in the first working portion.

3. The hand tool as claimed in claim 2, wherein
the first working portion further has at least one annular engaging groove defined around the first working portion; and
the handle further has a clamping notch defined in the end of the top of the handle that faces the first working portion, the clamping notch communicating with the through hole and having
two inner sides facing each other, and each inner side having at least one engaging rib formed on and protruding from the inner side and engaging respectively with the at least one engaging groove in the first working portion.

4. The hand tool as claimed in claim 3 further comprising a shock-absorbing gasket mounted around the connection bolt and clamped between the second working portion and the end of the top of the handle that faces the second working portion.

5. The hand tool as claimed in claim 1, wherein
the handle has a through hole defined through the two ends of the top;
the first working portion has a through hole defined through the first working portion and aligned with the through hole in the handle;
the second working portion has a threaded hole defined in an end of the second working portion facing the top of the handle and aligned with the through hole in the handle; and
a connection bolt is mounted through the through holes in the first working portion and the handle and is screwed with the threaded hole in the second working portion.

6. The hand tool as claimed in claim 5, wherein
the first working portion further has at least one annular engaging groove defined around the first working portion; and
the handle further has a clamping notch defined in the end of the top of the handle that faces the first working portion, the clamping notch communicating with the through hole and having
two inner sides facing each other, and each inner side having at least one engaging rib formed on and protruding from the inner side and engaging respectively with the at least one engaging groove in the first working portion.

7. The hand tool as claimed in claim 6 further comprising a shock-absorbing gasket mounted around the connection bolt and clamped between the second working portion and the end of the top of the handle that faces the second working portion.
